(19) United States
(12) Patent Application Publication
(10) Pub. No.: US 2010/0275717 A1
(43) Pub. Date: Nov. 4, 2010

(54) PRECISION POSITIONING DEVICE

(76) Inventors: Benoit Poyet, Versailles (FR); Jean David, Villeneuve D'Ascq (FR); Sebastien Ducourtieux, Poigny La Foret (FR)

Correspondence Address: HARNESS, DICKEY & PIERCE, P.L.C., P.O. BOX 828, BLOOMFIELD HILLS, MI, 48303, US

(21) Appl. No.: 12/433,137

(22) Filed: Apr. 30, 2009

(51) Int. Cl. G05G 11/00

(52) U.S. Cl. 74/479.01

(57) ABSTRACT

The invention relates to a precision positioning device comprising a base, moveable stage and four double parallelograms connecting the stage to the base. Each double parallelogram comprises six deformable vertices forming six pivots so that the stage can move in translation in a reference plane. Thanks to the four double parallelograms, the moveable stage is over-constrained so that the undesired rotational motions are very limited. The precision positioning device can further comprise a moveable platform connected to the moveable stage thanks to flexure strips. The moveable platform is over-constrained to only move in translation according to the Z axis.

### TECHNICAL FIELD

The present invention relates to an ultra-precision positioning apparatus and more specifically to an ultra-precision positioning apparatus for precisely performing a fine positioning of the submicron order without rotational motion.

### BACKGROUND ART

The importance of ultra-precision positioning technology has gradually increased in a variety of industrial fields. In particular, the development of ultra-precision measurements fields, such as atomic force microscope (AFM) or scanning electron microscope (SEM), has led to improved precision positioning technology.

Various of ultra-positioning feeding devices are known. For example, the document U.S. Pat. No. 7,239,107 discloses a flexure positioning technique comprising a base, a moveable stage and a positioning mechanism coupled between the base and the stage to move the stage in translation. However, the positioning mechanism is very complex, which leads to increased risks of imprecision.

Furthermore, the rotation motion of the mobile part is not well controlled and may lead to inaccuracy of the translation motion.

There is a need for a simplified ultra-precision positioning apparatus that will eliminate the three degrees of freedom of rotation of the mobile part so that only two or three degrees of freedom of translation remain.

### SUMMARY OF THE INVENTION

The foregoing shortcomings of the prior art are addressed by the present invention. An object of the present invention is to improve the translation quality and to reduce the undesired rotational motion.

Another object of the present invention is to provide a precision positioning apparatus with simplified design.

In order to achieve the above mentioned objects, the precision positioning apparatus according to the invention comprises:
a base having a number N of at least three base sides perpendicular to a common reference plane;
a moveable stage having N stage sides parallel to the N base sides;
N linkage mechanisms,
   wherein each linkage mechanism consists of five connecting rods articulated to one another and to one of the base sides and one of the stage sides via hinges so as to form, with said one of the base sides and said one of the stage sides, a double parallelogram, the hinges having parallel pivot axes, whereby the stage is constrained to only move in translation parallel to the reference plane and without rotational motion.

According to one embodiment, the hinges are circular flexure notch hinges.

According to a preferred embodiment, the rigid base, the moveable r stage and the N linkage mechanisms are machined in a monolithic metallic block, made e.g. from an aluminium alloy, preferably a 7075 aluminium alloy, or from another metallic material such as steel, Invar, copper or titanium.

According to a preferred embodiment, the number N is equal to 4, the rigid base and moveable stage being both rectangular and preferably square.

Advantageously, the moveable stage can be provided with a through hole having an axis perpendicular to the reference plane. This through hole can be used e.g. for illuminating from below a sample positioned on the moveable stage above the through hole. In another application, the through hole can be use to receive a moveable platform, which can move relative to the moveable stage parallel to the axis of the through hole, i.e. perpendicular to the reference plane.

According to an embodiment, the apparatus further comprises a plurality of actuators, each being connected to the moveable rectangular stage to provide motion thereto.

Advantageously, the apparatus according to the invention further comprises at least two position sensors, which can be e.g. interferometers or capacitive, inductive or ultrasonic transducers for measuring the motion of the moveable rectangular stage.

According to still another aspect of the invention, the apparatus according to the invention may further comprises:
a moveable platform connected to the moveable stage at least one set of two flexure leaves,
   wherein each flexure leave has one end connected to the moveable platform and an other end connected to the moveable stage so that the moveable platform is constrained to only translate perpendicularly to the reference plane with respect to the moveable stage without rotational motion.

The sets of flexure strips are evenly distributed at the periphery of the moveable platform.

The apparatus may further comprise an actuator connected to the moveable platform to provide motion thereto perpendicular to the reference plane.

According to another aspect of the invention, there is provided a monolithic metallic block comprising:
a base with N base sides, wherein N is an integer greater than or equal to 3,
a moveable stage with N stage sides parallel to the N base sides,
N linkage mechanisms connecting the base and the moveable stage, each of the linkage mechanisms comprising five connecting rods forming a double parallelogram with one of the base sides and one of the stage sides, the double parallelogram eight parallel pivot axes perpendicular to a reference plane, whereby the stage is constrained to only translate in the reference plane without rotational motion.

Advantageously, in the block according to the invention:
one of the five connecting rods forms a central connecting rod parallel to one of the four base sides and equidistant from this one of the four base side and one of the four stage sides,
the other four connecting rods of the five connecting rods are symmetric with respect to central connecting rod.

Advantageously, the central connecting rod is connected to each of the other four connecting rods thanks to two flexure notch hinges.

Advantageously, each connecting rod comprises a rectangular bar.

Advantageously, the double parallelograms are symmetric with respect to an axis perpendicular to the reference plane.

According to a further aspect of the invention, there is provided a micrometric positioning apparatus comprising:
a monolithic metallic block as described above;
actuators for providing motion to the moveable stage with respect to the base,
at least one position sensor for measuring a displacement of the moveable stage with respect to the base.

Advantageously, the micrometric positioning apparatus according to the invention further comprises:
a moveable platform connected to the moveable stage by flexure strips,
at least one actuator connected to the moveable platform to provide motion thereto,
   wherein each strip comprises two ends, one end being rigidly fixed to the moveable stage and the other end being rigidly fixed to the moveable platform, whereby the moveable platform is constrained to only translate vertically without rotational motion.

Advantageously, the strips are regularly distributed at the periphery of the moveable platform.

According to yet another aspect of the invention, there is provided a precision positioning device comprising:
a hollow support platform comprising an upper outer clamping jaw and a lower outer clamping jaw fixed to one another;
an inner core received within the hollow base and spaced apart from the hollow base, the inner core comprising an upper inner clamping jaw and a lower inner clamping jaw fixed to one another;
a set of at least a one monolithic metallic flat guiding sheet comprising an outer annular frame sandwiched between the upper outer clamping jaw and the lower outer clamping jaw, an inner plate located within the outer annular frame and received between the upper inner clamping jaw and the lower inner clamping jaw and at least two opposite flexure strips extending between the outer annular frame and the inner plate and connecting the outer annular frame with the inner plate,
   whereby flexure of the flexure strips results in translation of the inner core with respect to the hollow support platform in a direction perpendicular to the reference plane without rotation within or translation parallel to the reference plane.

This unidirectional precision positioning apparatus can be used in connection with the bidirectional positioning apparatus according to the first aspect of the invention, to provide a third degree of freedom of translation. It can also be used independently, to provide one degree of freedom of translation.

The shape and dimensions of the flexure strips are preferably identical. The flexure strips preferably have a constant rectangular cross-section. Each flexure strip realises a beam restrained at its longitudinal ends by the clamping jaws and defines a longitudinal neutral axis extending from the inner plate to the outer annular frame. The neutral axes of the two opposite strips are preferably parallel, and can be aligned.

If necessary, more than two flexure strips, e.g. three or four strips, may be provided between the inner plate and outer annular frame of the at least one guiding sheet. Preferably the strips should be regularly distributed around the inner plate, i.e. the angle between the neutral axes of two adjacent strips should be constant. Multiplying the number of strips increases the guiding accuracy. This is particularly true where the material from which the guiding sheet is made is isotropic.

According to one embodiment, the first guiding sheet is made of an anisotropic metallic material having a longitudinal fibres extending in a longitudinal direction parallel to the reference plane, e.g. a chrysocolla, which is an alloy of copper, tin and zinc exhibiting interesting mechanical properties. In such a case, the guiding sheet is preferably provided with only one pair of opposite flexure strips, “opposite” meaning having parallel, and preferably identical neutral axes, such that the orientation of the fibres in the material of the strips is at the same angle with respect to the neutral axes for the two strips, ensuring identical behaviour of the two strips in particular in terms of material fatigue caused by repeated variations of stress.

It may also prove advantageous, instead of multiplying the number of strips on one and the same guiding sheet, to provide at least a second guiding sheet identical with the first guiding sheet, parallel to the reference plane and oriented at and angle within the reference plane relative to the first guiding sheet. Hence, it is possible to provide more than one pair of flexure strips for guiding the moveable core of the positioning apparatus, while ensuring that the orientation of the fibres with respect to the longitudinal axis of each strip is identical. If the set of guiding sheets consists of P identical sheets, where P is an integer greater than 1, the angle between two consecutive sheets should preferably be 180°/P.

In order to ensure that the orientation of the fibres in each guiding sheet is the same, the guiding sheets should preferably be machined from one and the same sheet by one and the same machine.

Advantageously, the second guiding sheet can be directly laid on the first guiding sheet.

In order to provide a translation of the moveable core, the precision positioning apparatus may further include:
one actuator for providing motion to inner core with respect to the hollow support platform in a direction perpendicular to the reference plane,
at least one position sensor for measuring a displacement of the inner core with respect to the hollow support platform in said direction.

In order to reach the desired accuracy of the deflection of the flexure strips, one major challenge is to ensure that the ends of all flexure strips are restrained in the same way. To ensure this, it may prove advantageous to provide:
at least one intermediate monolithic outer annular flat sheet interleaved between the at least one guiding sheet and one of the upper and lower outer clamping jaws, and
at least intermediate monolithic inner flat sheet interleaved between the at least one guiding sheet and said one of the upper and lower inner clamping jaws.

This interleaved sheets can be machined (cut) with more accuracy than the clamping jaws, and will define sharp edges for delimiting on the one hand the part of the guiding sheets that is clamped between the clamping jaws and on the other hand the part of the flexure strips that is bendable.

The unidirectional precision positioning defined above ensures that the translation in a direction perpendicular to the reference plane does not generate any parasitic rotation of the moveable core in the reference plane, i.e. about the an axis parallel to the translation axis. In order to eliminate the parasitic rotation out of the reference plane, i.e. about an axis perpendicular to the translation axis, it may be appropriate to duplicate the first guiding sheet with a second guiding sheet located at a distance from the first guiding sheet along the translation axis. Hence, according to one embodiment of the invention: the hollow base comprises an intermediate outer clamping jaw fixed to the lower and upper outer jaws, the inner core comprises an intermediate inner clamping jaw fixed to the lower and upper inner clamping jaw, the first guiding sheet being a lower guiding sheet sandwiched between the lower and intermediate clamping jaws, the set further comprising an upper metallic flat guiding sheet identical with the first guiding sheet sandwiched between the upper and further clamping jaws, whereby flexure of the flexure strips results in translation of the inner core with respect to the hollow support platform in a direction perpendicular to the reference plane without rotation.

Preferably, the distance between the lower and upper guiding sheets should be at least of the same order as the length of the flexure strips, and preferably at least twice this length.

As stated before, the unidirectional precision positioning apparatus described previously can be combined with a bidirectional positioning apparatus according to the first aspect of the invention to provide a tridirectional system. Hence, according to another aspect of the invention, there is provided a precision positioning apparatus comprising:
a monolithic metallic block comprising:
a hollow base having N inner base sides, wherein N is an integer greater than or equal to three,
a moveable stage having N outer stage sides each facing a respective one of the N base sides, and
N linkage mechanisms connecting the base and the moveable stage, each of the linkage mechanisms comprising five connecting rods forming a double parallelogram with one of the base sides and one of the stage sides, the double parallelogram comprising eight parallel pivot axes perpendicular to a reference plane, whereby the stage is constrained to only translate in the reference plane without rotational motion,

the precision positioning apparatus further comprising:
an upper outer clamping jaw and a lower outer clamping jaw fixed respectively to an upper side and a lower side of the moveable stage;
an inner core received within a through hole of the moveable stage and spaced apart from the hollow base, the inner core comprising an upper inner clamping jaw, and intermediate inner clamping jaw and a lower inner clamping jaw fixed to one another;
a set of identical monolithic metallic flat guiding sheets each comprising an outer annular frame sandwiched an inner plate located within the outer annular frame and at least two opposite flexure strips extending between the outer annular frame and the inner plate and connecting the outer annular frame with the inner plate, the set of guiding sheets comprising at least one upper guiding sheet sandwiched between the upper clamping jaws and the moveable stage, and one lower guiding sheet sandwiched between the moveable stage and the lower clamping jaws,
   whereby flexure of the flexure strips results in translation of the inner core with respect to the moveable stage in a direction perpendicular to the reference plane without rotation within the reference plane.

### BRIEF DESCRIPTION OF THE DRAWINGS

Other advantages and features of the invention will become more clearly apparent from the following description of a specific embodiment of the invention given as non-restrictive example only and represented in the accompanying drawings in which:

FIG. 1 is a top view of a precision positioning apparatus according to the invention;

FIG. 2 is a schematic view of a circular flexure notch hinge according to the invention;

FIG. 3 is an isometric view of a double parallelogram of the apparatus of FIG. 1;

FIG. 4 is a partial isometric view showing a Z-stage of the apparatus of FIG. 1;

FIG. 5 is an exploded view of a stack of metallic sheets used to suspend the Z-stage of FIG. 4.

### BEST MODE FOR CARRYING OUT THE INVENTION

Hereinafter, a preferred embodiment of an ultra precision positioning apparatus according to the invention will be described in detail with reference to the accompanying drawings.

It will nevertheless be understood that no limitation of the scope of the invention is thereby intended. Any alterations and further modifications of the described embodiments, and any further applications of the principles of the invention as described herein, are contemplated as would normally occur to one skilled in the art to which the invention relates.

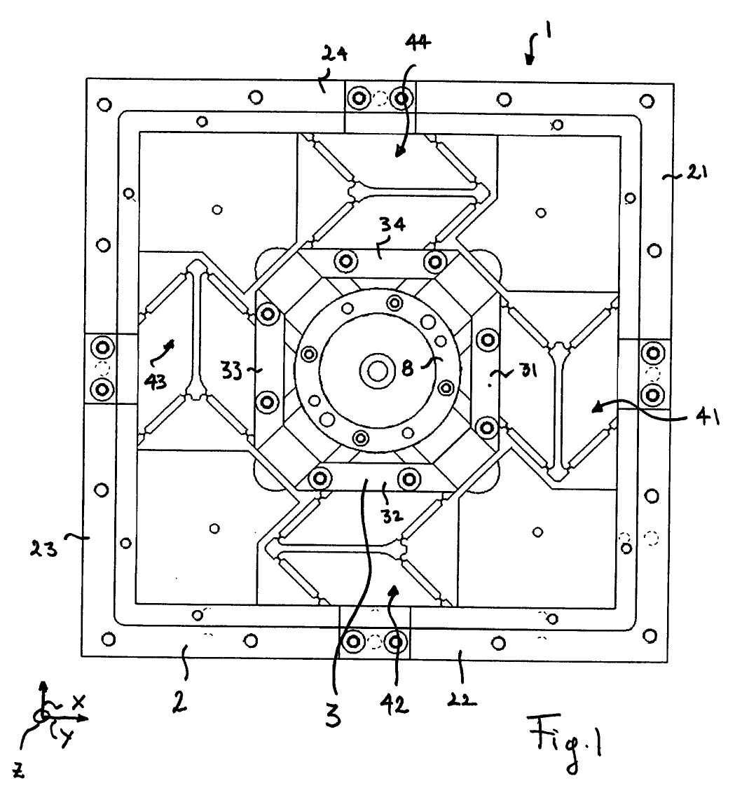

FIG. 1 depicts a biaxial precision positioning apparatus 1. The apparatus 1 comprises a stationary, rectangular hollow base or frame 2 and a rectangular stage 3, which is moveable in translation in a reference plane XY relative to the base 2. The reference plane XY is the geometric plane, which comprises the axes X and Y and is perpendicular to the axis Z. In use, the axis Z will preferably be vertical.

The base 2 comprises four base sides 21, 22, 23 and 24 forming four inner walls facing the stage. Similarly, the stage 3 comprises four stage sides 31, 32, 33 and 34 forming four walls, each facing one of the walls of the base such that the facing walls are parallel and equidistant. Each stage side 31 is parallel to one base side 21. The stage 3 is connected to the base 2 thanks to four linkage mechanisms 41, 42, 43 and 44.

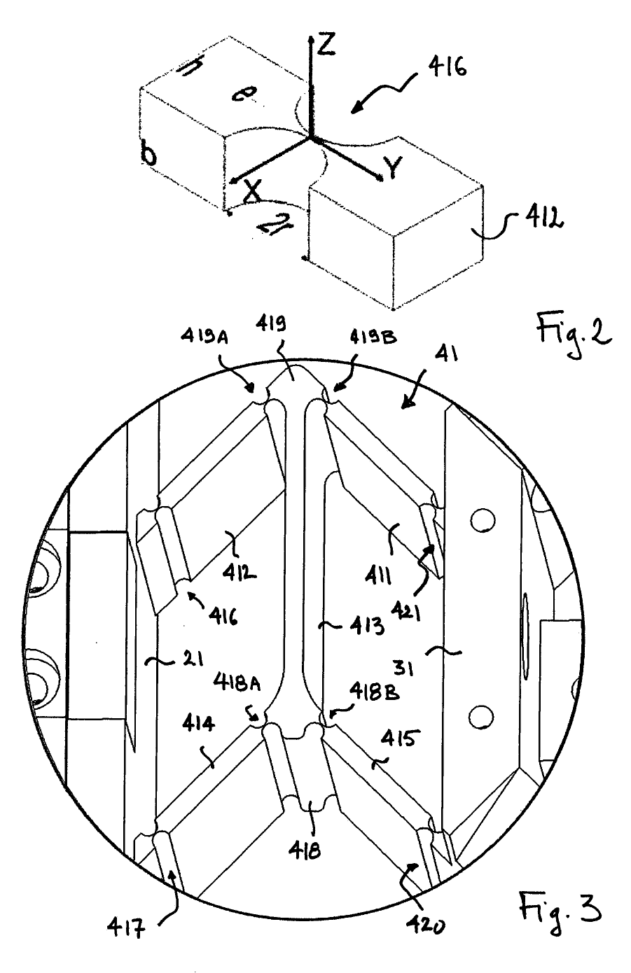

Each linkage mechanism 41, 42, 43 and 44, as more precisely represented in FIG. 3, comprises five connecting rods 411, 412, 413, 414 and 415. The five connecting rods 411, 412, 413, 414, 415, one of the base sides 21 and one of the stage sides 31 form an articulated double parallelogram or pantograph. The stage 3 is then over-constrained by the four double parallelograms.

The double parallelograms are arranged so that two opposite double parallelograms 41 and 43, or 42 and 44, are symmetric with respect to a vertical axis 5 going through the centre of the stage.

Each double parallelogram is arranged so the connecting rod 413 is placed at equal distance from the stage side 21 and the base side 31. This central connecting rod 413 is parallel to the stage side 21 and to the base side 31. Two pairs of lateral connecting rods 411, 414 and 412, 415 protrude on each side of the central connecting rod 413 and connect the central connecting rod 413 to the stage side 21 and the base side 31, respectively. The angle between the central connecting rod 413 and each of the lateral connecting rods 411, 412, 414, 415 is approximately 45°.

Each lateral connecting rod consists of a bar having a rectangular section and provided with a circular flexure notch hinge at each end. Each circular flexure notch hinge is elastically deformable thereby constituting a pivot joint, which is adapted to small angles of rotation. The circular flexure notch hinge, illustrated more precisely in FIG. 2, can only pivot in the XY reference plane about an axis parallel to the axis Z. Movements outside this reference plane are restrained and practically impossible. In this example, the maximum rotation angle of the circular flexure notch hinge is about 100 mrad. The stiffness of the connecting rods is adapted so that they can only pivots in the XY reference plane without torsional or rotational motion. More precisely, the pitch, yaw and roll deviations are less than 1 μrad for the whole range.

There is a total of height circular flexure notch hinges 416, 417, 418a, 418b, 419a, 419b, 420, 421 per double parallelogram. The height circular flexure notch hinges 416, 417, 418a, 418b, 419a, 419b, 420, 421 form eight pivots positioned at one of the vertices 416, 417, 418, 419, 420, 421 of the double parallelogram and has a pivot axis parallel to the axis Z. The deformation of these pivots produces translation of the stage side 31 in the XY reference plane as represented in FIG. 5. These deformations of the pivots are allowed by the low stiffness of the circular flexure notch hinges. The higher transverse stiffness constrains the other degrees of freedom: three rotations and the out-of-plane motion.

Only one double parallelogram is sufficient to provide two degrees of freedom but the chosen over-constrained arrangement, with four double parallelograms, increases guidance performances: the four double parallelograms arrangement increases the equivalent transverse stiffness and reduces the global undesired motion. In the perfect case where all the flexure hinges are identical and parallel, the only degrees of freedom of the XY stage are the two translations parallel to the X and Y axes.

To approach this ideal case, the precision positioning apparatus have been machined in a monolithic alloy by EDM to guarantee the double parallelograms symmetry and above all the position and dimension of each flexure hinge, i.e. the thickness and the stiffness of the circular flexure notch hinges.

The precision positioning apparatus according to the invention further comprises a plurality of actuators connecting the XY stage to the base and providing motion to the XY stage with respect to the base. Preferably, the precision positioning apparatus comprises four actuators, which are disposed symmetrically around the XY stage. Each actuator is able to push on a stage side thereby providing deformation of the six pivots formed by the circular flexure notch hinges, thereby providing translation of the stage side along the axis X or along the axis Y. The over constrained arrangement guarantees that the stage can not rotate during this translation. Moreover, the translation occurs only in the XY reference plane and no motion parallel to Z axis is possible.

The actuators can be, for example, electrostatic, electromagnetic or piezoelectric. The apparatus is provided with displacement sensors to control the motion of the stage.

With this precision positioning apparatus cast in one piece, the undesired rotational motions measured are in the range of 1.3 μrad for a 100 μm displacement with a first resonance at 170 Hz.

When used in an AFM, the precision positioning apparatus according to the invention is also provided with four dual path and differential interferometers for the position measurement of the stage relative to the tip of the AFM.

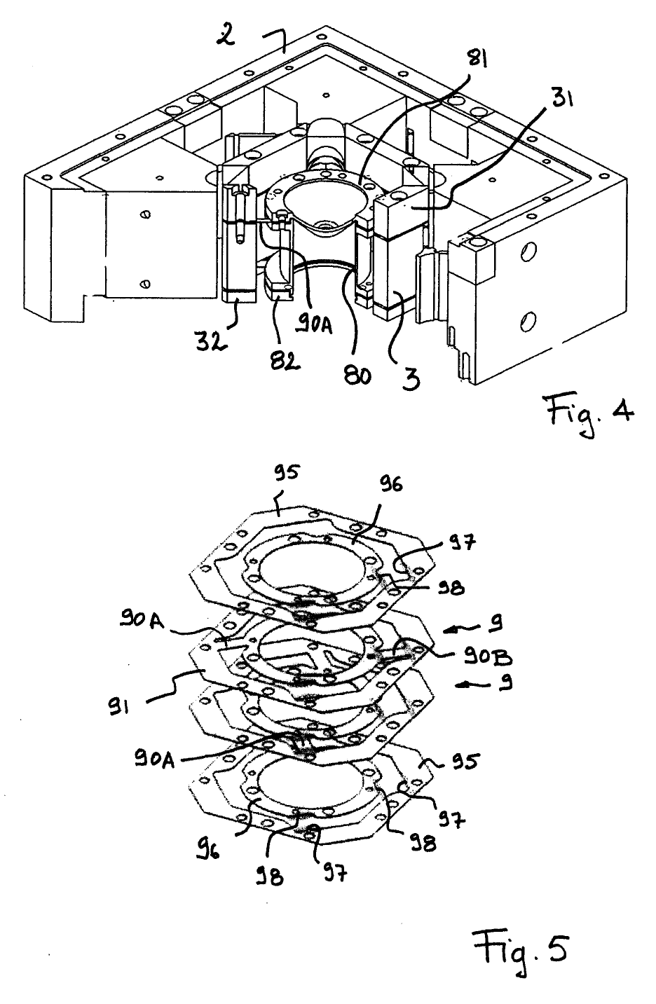

Moreover, the precision positioning apparatus according to the invention is also provided with a platform or Z-stage 8, which is represented more precisely in FIGS. 4 and 5. The platform 8 is cylindrical. The platform 8 is connected to the XY stage thanks to guiding sheets 9 shown in FIG. 5.

The strips are part of monolithic flat guiding sheets 9 illustrated in FIG. 5. Each guiding sheet is flat and made of a metal alloy, which in this case has anisotropic structure. Each guiding sheet comprises an outer annular frame 91, an inner plate 92 located within the outer annular frame and at least two opposite flexure strips 90A, 90B extending between the outer annular frame and the inner plate and connecting the outer annular frame with the inner plate. The two opposite flexure strips have parallel longitudinal axes. In this particular example, the neutral axes of the two strips are not identical, to increase the compactness of the device. As illustrated in FIG. 5, two identical guiding sheets are placed one on top of the other, rotated at 90° in the reference plane to provide two parallel adjacent layers.

The sandwich of sheets is clamped between the movable stage and an upper outer clamping jaw 30 via a set of bolts. Similarly, the two sheets are sandwiched between an inner cylindrical core 80 of the Z-stage 8 and an upper inner clamping jaw 81 via bolts.

Preferably, two additional pairs of external and internal flat sheets 95, resp. 96 are placed on top and below the two guiding sheets 9, interleaved between the guiding sheets and the massive parts. All the sheets cut from the same basic planar sheet of metal alloy, preferably in one and the same machining operation. Remarkably, each of the sheets is provided with two rectilinear edges 93, 94, 97, 98, which are place directly on top or directly below the end of one of the flexure strips 90A, 90B. Great care is taken during the cutting process to ensure the accuracy of the dimensions of these edges.

The moveable stage 8 of the monolithic metallic bloc is linked to the Z-stage via the flexure strips, which are evenly distributed at the periphery of the cylindrical core.

Similarly, a second set of two guiding sheets and two pairs of interleaved sheets is clamped between the inner core 80 and moveable stage 3 on the one hand, and a set of lower inner and outer clamping jaws 32, 82.

The dimensions of the eight flexure strips are identical and their ends are precisely restrained between the edges 93, 94, 97, 98 of the adjacent sheets. Each flexure strip forms an ideal beam constrained at both ends and presents a rectangular cross-section.

The platform is further coupled to an actuator enabling to translate the platform 8 parallel to the Z-axis. When the actuator translates the platform 8, the flexure strips bend. As the strips are identical and equally distributed at the circumference of the inner core, the bending of the strips leads to the translation of the platform 8 along the Z-axis.

The arrangement of the flexure strips constraints all directions except the movement along the Z axis by minimizing circular deviations because strain is symmetrically distributed around the mobile cylinder. For a 10 μm displacement along the Z axis, which corresponds with a 1 mrad bending angle, elongation of each strip is about five nanometers. Three flexure strips should be sufficient but the four-strip configuration is more symmetrical: elastic forces are balanced between the four flexure strips, minimizing the rotations and straightness errors.

Moreover, the second stack of flexure strips, at the bottom of the mobile cylinder increases the translation guidance because pitch and tilt motions are constrained more efficiently by the tension/compression stiffness of the leaf type strips. For a given unwanted rotation of the mobile cylinder (for example 1 μrad), the equivalent tension of the lower strip is proportional to the cylinder height. Hence, the longer the cylinder is (i.e. the distance between the stacks of sheets, the more constrained the rotations will be. In one experimental prototype, the elongation for a 1 μrad unwanted rotation is about 30 nm, which corresponds to a 210 N force, which is about one thousand times higher than the force necessary for a 10 μm displacement along the Z axis (about 0.2 N). In this respect, it can be considered that this parasitical movement is fully constrained. In other words, this symmetric arrangement of the flexure strips provides an over-constrained configuration, which has only one degree of freedom: the translation parallel to the Z axis, which is perpendicular to the sheets.

It should be understood that various changes, substitutions and alterations can be made herein without departing from the spirit and scope of the following claims. While the preferred embodiment described above has a rectangular base and a rectangular stage, other polygonal shapes, preferably regular polygons such as an equilateral triangle, a regular pentagon or hexagon, may be contemplated. While the monolithic X-Y stage is combined with a Z-stage, it is also contemplated that both stages can be implemented independently from one another.

1. A precision positioning apparatus comprising:
a hollow base having N internal base sides, N being an integer greater than or equal to three, the N internal base sides being perpendicular to a common reference plane;
a moveable stage having N stage sides each parallel to a respective one of the N base sides;
N linkage mechanisms;
wherein each linkage mechanism consists of five connecting rods articulated to one another and to one of the stage sides and the respective one of the stage sides via hinges so as to form, with said one of the base sides and respective one of the stage sides, a double parallelogram, the hinges having parallel pivot axes perpendicular to the reference plane, whereby the stage is constrained to only move in translation in the reference plane without rotational motion.

2. The apparatus of claim 1, wherein the hinges are circular flexure notch hinges.

3. The apparatus of claim 1, wherein the rigid base, the moveable stage and the N linkage mechanisms are machined in a monolithic metallic block.

4. The apparatus of claim 1, further comprising two actuators, each being connected to the moveable rectangular stage to provide motion thereto.

5. The apparatus of claim 1, further comprising position sensors for measuring the motion of the moveable stage.

6. The apparatus of claim 1, further comprising:
a moveable platform connected to the moveable stage by at least two flexure strips;
wherein each strip has one end connected to the moveable platform and an other end connected to the moveable stage so that the moveable platform is constrained to only translate with respect to the moveable stage in a direction perpendicular to the reference plane and without rotational motion.

7. A monolithic metallic block comprising:
a hollow base having N inner base sides, wherein N is an integer greater than or equal to three;
a moveable stage having N outer stage sides each facing a respective one of the N base sides;
N linkage mechanisms connecting the base and the moveable stage, each of the linkage mechanisms comprising five connecting rods forming a double parallelogram with one of the stage sides and the respective base side, each double parallelogram comprising six vertices, each of the six vertices being provided with at least one flexure notch hinge being elastically deformable, the six vertices thereby defining six parallel pivot axes, the double parallelogram defining a reference plane perpendicular to the six pivot axes, whereby the stage is constrained to only translate in the reference plane without rotational motion.

8. The block of claim 7, wherein in each linkage mechanism:
one of the five connecting rods forms a central connecting rod parallel to one of the stage sides and equidistant from said one of the base sides and the respective base side;
the other four connecting rods of the five connecting rods are disposed symmetrically with respect to central connecting rod.

9. The block of claim 7, wherein each connecting rod comprises a rectangular bar.

10. The block of claim 7, wherein the double parallelograms are symmetric with respect to a common axis perpendicular to the reference plane.

11. A micrometric positioning apparatus comprising:
the monolithic metallic block of claim 9;
two actuators for providing motion to the moveable stage with respect to the base parallel to the reference plane;
at least one position sensor for measuring a displacement of the moveable stage with respect to the base.

12. The micrometric positioning apparatus of claim 11, further comprising:
a moveable platform connected to the moveable stage by at least two flexure strips;
wherein each flexure strip comprises one end connected to the moveable stage and another end connected to the moveable platform;
whereby the moveable platform is constrained to only translate vertically without rotational motion.

13. A precision positioning apparatus comprising:
a hollow support platform comprising an upper outer clamping jaw and a lower outer clamping jaw fixed to one another;
an inner core received within the hollow base and spaced apart from the hollow base, the inner core comprising an upper inner clamping jaw and a lower inner clamping jaw fixed to one another;
a set of at least a one monolithic metallic flat guiding sheet comprising an outer annular frame sandwiched between the upper outer clamping jaw and the lower outer clamping jaw, an inner plate located within the outer annular frame and received between the upper inner clamping jaw and the lower inner clamping jaw and at least two flexure strips extending between the outer annular frame and the inner plate and connecting the outer annular frame with the inner plate;
whereby flexure of the flexure strips results in translation of the inner core with respect to the hollow support platform in a direction perpendicular to the reference plane without rotation within the reference plane.

14. The precision positioning apparatus of claim 13, wherein the outer clamping jaws are provided with planar faces facing one another and the inner clamping jaws are provided with planar face facing one another.

15. The precision positioning apparatus of claim 13, wherein the first guiding sheet is made of an anisotropic metallic material having a longitudinal fibres extending in a longitudinal direction parallel to the reference plane, the set further comprising at least a second guiding sheet identical with the first guiding sheet, parallel to the reference plane and oriented at 90° within the reference plane relative to the first guiding sheet.

16. The precision positioning apparatus of claim 15, wherein the second guiding sheet is directly laid on the first guiding sheet.

17. The precision positioning apparatus of claim 13, further comprising:
one actuator for providing motion to the inner core with respect to the hollow support platform in a direction perpendicular to the reference plane;
at least one position sensor for measuring a displacement of the inner core with respect to the hollow support platform in said direction.

18. The precision positioning apparatus of claim 13, further comprising:
at least one intermediate monolithic outer annular flat sheet interleaved between the at least one guiding sheet and one of the upper and lower outer clamping jaws; and
at least intermediate monolithic inner flat sheet interleaved between the at least one guiding sheet and said one of the upper and lower inner clamping jaws.

19. The precision positioning apparatus of claim 13, wherein:
the hollow base comprises an intermediate outer clamping jaw fixed to the lower and upper outer jaws;
the inner core comprises an intermediate inner clamping jaw fixed to the lower and upper inner clamping jaw;
the first guiding sheet being a lower guiding sheet sandwiched between the lower and intermediate clamping jaws, the set further comprising an upper metallic flat guiding sheet identical with the first guiding sheet sandwiched between the upper and further clamping jaws,
whereby flexure of the flexure strips results in translation of the inner core with respect to the hollow support platform in a direction perpendicular to the reference plane without rotation.

20. A precision positioning apparatus comprising:
a monolithic metallic block comprising:
a hollow base having N inner base sides, wherein N is an integer greater than or equal to three,
a moveable stage having N outer stage sides each facing a respective one of the N base sides, and
N linkage mechanisms connecting the base and the moveable stage, each of the linkage mechanisms comprising five connecting rods forming a double parallelogram with one of the stage sides and the respective base side, each double parallelogram comprising six vertices, each of the six vertices being provided with at least one flexure notch hinge being elastically deformable, the six vertices thereby defining six parallel pivot axes, the double parallelogram defining a reference plane perpendicular to the six pivot axes, whereby the stage is constrained to only translate in the reference plane without rotational motion;
the precision positioning apparatus further comprising:
an upper outer clamping jaw and a lower outer clamping jaw fixed respectively to an upper side and a lower side of the moveable stage;
an inner core received within a through hole of the moveable stage and spaced apart from the hollow base, the inner core comprising an upper inner clamping jaw, and intermediate inner clamping jaw and a lower inner clamping jaw fixed to one another;
a set of identical monolithic metallic flat guiding sheets each comprising an outer annular frame, an inner plate located within the outer annular frame and at least two opposite flexure strips extending between the outer annular frame and the inner plate and connecting the outer annular frame with the inner plate, the set of guiding sheets comprising at least one upper guiding sheet sandwiched between the upper clamping jaws and the moveable stage, and one lower guiding sheet sandwiched between the moveable stage and the lower clamping jaws,
whereby flexure of the flexure strips results in translation of the inner core with respect to the moveable stage in a direction perpendicular to the reference plane without rotation within the reference plane.
